(19) United States
(12) Patent Application Publication
(10) Pub. No.: US 2011/0061667 A1
(43) Pub. Date: Mar. 17, 2011

(54) FLAVOR-CONTAINING MATERIAL FOR CIGARETTE, PROCESS FOR PRODUCING THE SAME, AND CIGARETTE

(76) Inventors: Yasuo TANAKA, Yokohama-shi (JP); Tatsuya Kusakabe, Yokohama-shi (JP); Yuji Yamamoto, Yokohama-shi (JP)

(21) Appl. No.: 12/949,531

(22) Filed: Nov. 18, 2010

Related U.S. Application Data
(63) Continuation of application No. PCT/JP2009/059079, filed on May 15, 2009.

(30) Foreign Application Priority Data
May 19, 2008 (JP) 2008-131087

(51) Int. Cl. A23L 1/05; A23L 1/22; A24B 15/30; A23L 1/0522; A23L 1/0526; A23L 1/0528; A23L 1/0532; A23L 1/054

(52) U.S. Cl. 131/352; 426/573; 426/575; 426/578

(57) ABSTRACT

There is provided a flavor-containing material for cigarette in which a flavor is coated with a polysaccharide without need of addition of a gelling agent such as a metal chloride.

### CROSS REFERENCE TO RELATED APPLICATIONS

This is a Continuation Application of PCT Application No. PCT/JP2009/059079, filed May 15, 2009, which was published under PCT Article 21(2) in Japanese.

This application is based upon and claims the benefit of priority from prior Japanese Patent Application No. 2008-131087, filed May 19, 2008, the entire contents of which are incorporated herein by reference.

### BACKGROUND OF THE INVENTION

1. Field of the Invention

The present invention relates to a flavor-containing material for cigarette, a process for producing the material, and a cigarette.

2. Description of the Related Art

When menthol cigarettes are produced, a method of adding a flavor component such as menthol to cut tobacco in a solution state is adopted. This method has an advantage that by spraying or some other operation of the flavor solution, the flavor components can easily be added to the cut tobacco. However, when the addition amount of the flavor is increased in order to release a sufficient aroma at the time of smoking, the amount of a solvent is also increased. Therefore, at the time of the addition of the flavor solution, components containing a colorant and others are extracted from the cut tobacco with the solvent, so that a “stain” tends to be generated on the cigarette wrapper. Moreover, the flavor components, such as menthol, have volatility, so as to result in a drawback that the flavor components are dissipated when the cigarettes are stored over a long term, so that the flavor effect does not last. Furthermore, in the case of using a cigarette in which a charcoal filter is used to remove unpleasant taste in mainstream smoke of the cigarette, the flavors are adsorbed to the charcoal during a storage period, so that the flavors are significantly volatilized and dissipated, and thus, the cigarette also has a drawback that a decrease in the flavor effect becomes significant in storage.

Against this, techniques of encapsulating flavor components and adding the encapsulated components to a cigarette are reported in Japanese Patent No. 3790828 and Jpn. Pat. Appln. KOKAI Publication No. 4-75578. When such flavors are added to a cigarette, there is not caused a problem that the cigarette wrapper is stained as described above. Since the flavor components are encapsulated, the flavor components are restrained from being volatilized and dissipated when the cigarette is stored. However, in any one of the methods, a coating agent is gelled and brought into contact with the flavors to encapsulate the flavors. When the coating agent is gelled, the addition of a gelling agent, such as a metal chloride, is required. The addition of such a metal chloride causes a problem that, when the cigarette is combusted, a thermal decomposition product of the metal halide is entrained in the mainstream smoke. Furthermore, the method of Jpn. Pat. Appln. KOKAI Publication No. 4-75578 requires crashing the flavor-containing capsule when the cigarette is smoked.

### BRIEF SUMMARY OF THE INVENTION

An object of the present invention is to provide a flavor-containing material for cigarette in which a flavor is coated with a polysaccharide without adding any gelling agent, such as a metal chloride, to the material.

Another object of the invention is to provide a flavor-containing material for cigarette having high flavor content.

A further object of the invention is to provide a flavor-containing material for cigarette for which an operation of crushing capsules and some other operation are not required at the time of smoking.

According to the present invention, there is provided a flavor-containing material for cigarette wherein a flavor is coated with a gel of a polysaccharide containing no gelling agent.

### BRIEF DESCRIPTION OF THE SEVERAL VIEWS OF THE DRAWING

FIG. 1 is a graph showing a flavor-retaining property when the storage of a cigarette is continued under normal environment conditions.

FIG. 2 is a graph showing a flavor-retaining property when the storage of a cigarette is continued under accelerated environment conditions.

### DETAILED DESCRIPTION OF THE INVENTION

The present invention will be described in more detail hereinafter.

In the flavor-containing material for cigarette according to the invention, a flavor is coated with a gel of a polysaccharide that contains no gelling agent.

As the flavor, various flavors may be used. For example, l-menthol may be used.

The polysaccharide used in the invention can be gelled only by temperature control. Thus, no gelling agent is required. Accordingly, the flavor-containing material for cigarette according to the invention contains no gelling agent such as a metal chloride. Thus, for example, an unfavorable decomposed product of the chloride is not produced in the mainstream smoke during smoking.

In order to increase the flavor content of the flavor-containing material, it is necessary that the flavor is effectively coated with the polysaccharide. The present inventors have found that it is effective that a flavor and a polysaccharide are sufficiently kneaded and emulsified in a heated aqueous solution, and the emulsified state that the flavor coated with the gelled polysaccharide is present in the aqueous solution is maintained while the flavor-containing material is prepared. That is, in a flavor-containing material that can be sufficiently kneaded and emulsified and can keep the emulsified state, high flavor content can be finally obtained. On the other hand, it has been found that, in a system that cannot keep the emulsified state in the aqueous solution during the preparation of the material even when sufficient kneading and emulsifying are performed, high flavor content cannot be attained. The flavor-containing material of the invention may contain 18 wt % or more, preferably 60 wt % or more, more preferably 70 wt % or more of flavor.

The polysaccharide that can keep an emulsified state as described above is preferably a single component system of carrageenan, agar, gellan gum, tamarind gum, psyllium seed gum or konjak glucomannan, or a composition system of combined two or more components selected from the group consisting of carrageenan, locust bean gum, guar gum, agar, gellan gum, tamarind gum, xanthan gum, tara gum, konjak glucomannan, starch, cassia gum and psyllium seed gum. At the time of the emulsification, it is preferred to use an ordinarily used emulsifier, such as lecithin, together.

By casting the flavor-containing material, prepared by kneading and emulsifying the flavor and the polysaccharide in an aqueous solution, on a substrate and drying, a sheet can be produced. This flavor-containing material sheet can be shredded and then added to cut tobacco.

The flavor-containing material can be kneaded and emulsified into a slurry state, which may be added to cut tobacco or a cigarette wrapper.

A cigarette to which the flavor-containing material for cigarette of the present invention is added has a higher flavor-retaining property than ordinary menthol cigarettes since the flavor is coated with the polysaccharide. For this reason, also when a charcoal filter is fitted thereto, the cigarette can have a flavor-retaining property without any problem.

The flavor-containing material for cigarette of the invention may be prepared by a process comprising steps of:

(i) mixing a polysaccharide with water and heating the mixture to prepare an aqueous solution of the polysaccharide; and

(ii) adding a flavor and an emulsifier to the aqueous solution and kneading and emulsifying the solution.

In the step (i), a polysaccharide and water is mixed with each other and then the mixture is once heated, whereby the polysaccharide is imparted a property capable of gelling in standing to cool. The heating temperature is preferably a temperature of 60 to 90° C. Effects of the heating include followings: the solubility of the gelled polysaccharide in water is improved; further, the polysaccharide is imparted a property capable of gelling in standing to cool; the flavor added in the step (ii) is made into a melted state and, at the same time, the viscosity of the aqueous solution of the polysaccharide is lowered, thereby facilitating the emulsification thereof with the flavor; further, it is found that, when the heated aqueous solution of the polysaccharide is kneaded and emulsified with the flavor in the step (ii), the emulsified state can be kept during preparation of the flavor-containing material.

Next, in the step (ii), a flavor and an emulsifier are added to the aqueous solution of the polysaccharide, and the mixture is kneaded and emulsified. Various types of flavor may be used as described above, and l-menthol, for example, may be used. The flavor is taken in the aqueous solution of the polysaccharide from the step (i) by kneading and is present in an emulsified state. As described above, this emulsified state is kept during preparation of the flavor-containing material, which makes it possible to prepare a flavor-containing material of high flavor content. In other words, a smoking article containing this flavor-containing material can produce a more aroma during smoking. The flavor content of the flavor-containing material is preferably 18% or more, more preferably 60% or more, in particular preferably 70% or more.

### EXAMPLES

Hereinafter, the invention will be described in more detail by way of examples.

Preparation of a flavor-containing material for cigarette according to the invention

A flavor-containing material for cigarette of the invention is prepared by use of a polysaccharide described below as a coating agent. Examples of the polysaccharide include carrageenan, which is extracted from red algae seaweed, agar, locust bean gum (carob gum), which is a galactomannan extracted from tree seeds, guar gum, tara gum, cassia gum, tamarind gum, which is extracted from tree seeds and has a structure of xyloglucan, psyllium seed gum, which is extracted from tree seeds and is an acidic polysaccharide having a structure having a main chain of xylan and side chains of arabinose or the like, xanthan gum or gellan gum (also notated as jellan gum), which is a polysaccharide produced by the metabolism of microorganisms, konjak glucomannan, which is extracted from tuberous roots of konjak, and any starch (which may be various raw materials thereof or soluble starch). Of them, carrageenan, gellan gum, tamarind gum, psyllium seed gum, konjak glucomannan or agar may be used as a single component system. The polysaccharide used in the present invention may be a composition system of combined two or more components selected from the group consisting of the above-mentioned polysaccharides. A process for preparing the flavor-containing material for cigarette of the present invention is as follows. First, while a polysaccharide (single component system or composition system) is heated, the polysaccharide is dissolved in water. To this aqueous solution at the above heating temperature, a flavor in a liquid state (or melted state) and an emulsifier are added, and then the liquid is kneaded and emulsified. Subsequently, in the state that this emulsified state is kept, the emulsion is cast and then the water in which the polysaccharide is dissolved is evaporated to form a sheet of the objective flavor-containing material for cigarette. With respect to a flavor-containing material for cigarette prepared using various types of polysaccharides, and a flavor delivery in cigarette smoke in a case where the material is added to a cigarette, actually examined results are described below as examples. The intended selection of flavors, combinations of two or more of the polysaccharides, types of an emulsifier, and others are mere examples. Needless to say, therefore, various modifications can be done without departing from the scope of the invention in light of the disclosure described hereinbefore, and the present invention is not limited by the examples.

### Example 1 to 3

κ-Carrageenan (CARRAGEENAN CS-530, San-Ei Gen F.F.I., Inc.), which is extracted from red algae seaweed was selected as a single polysaccharide and 1-menthol (special grade, Wako Pure Chemical Industries, Ltd.) was selected as a flavor, respectively. A flavor-containing material for cigarette of Example 1 was prepared by the following procedures.

To 5 g of κ-carrageenan added was 100 mL of water, which was heated in a thermostat bath of 80° C. to dissolve κ-carrageenan sufficiently in water. Added thereto were 25 g of l-menthol and 2 mL of a 5% aqueous solution of lecithin (Sunlecithin A-1, Taiyo Kagaku Co., Ltd.), which was sufficiently emulsified by means of a homogenizer (high performance mixer DMM, ATEC Japan Co., Ltd.). This emulsified slurry was cast on a substrate into a sheet form, which was dried in a forced air circulation dryer of 40° C. for one week (the thickness of the dried film: 0.1 mm). At this time, the emulsified state of the mixture was kept until the flavor-containing material was dried.

The prepared sheet-form flavor-containing material for cigarette of Example 1 contained about 80 wt % of menthol. Thus, a satisfactory amount of menthol could be added.

The flavor-containing material of the present invention also has a function of suppressing the volatility of the flavor. For example, the flavor-containing material for cigarette of Example 1 was continued to be stored under accelerated environment conditions (cyclic environments between a condition of 50° C. and 60% humidity for 14 hours and a condition of 30° C. and 70% humidity for 10 hours imitating the inside of a stock space of an automatic vending machine in summer). Also in this case, the flavor-containing material contained 73.5 wt % of menthol in the total weight of the material after one week, and 73.0 wt % after one month. From the results, it is found that the cigarette in which the flavor-containing material for cigarette according to the invention is added has a very high flavor-retaining property compared to any ordinary menthol cigarette having cut tobacco added with menthol, when the cigarette is stored over a long term or in a stock space of an automatic vending machine in summer and when a charcoal filter is fitted to the cigarette in order to remove unpleasant taste in the cigarette mainstream smoke.

Cigarettes were tested for menthol delivery. First, cigarette samples of Examples 2 and 3 fitted with a plain filter for which a tar value was designed to about 10 mg. Here, the cigarettes of Example 2 had cut tobacco added with 3% of the flavor-containing material for cigarette of Example 1, and the cigarettes of Example 3 had cut tobacco added with 5% of the flavor-containing material for cigarette of Example 1. At this time, in each of Examples 2 and 3, the flavor-containing material for cigarette of Example 1 could be added without causing the problem of a stain on the wrapper. The occurrence of a stain on the wrapper was observed visually. The cigarette of Example 2 provided a menthol delivery of 0.91 mg per cigarette (with a ratio of menthol to tar of 0.086), and the cigarette of Example 3 provided a menthol delivery of 2.09 mg per cigarette (with a ratio of menthol to tar of 0.186). These were sufficient deliveries for menthol cigarettes.

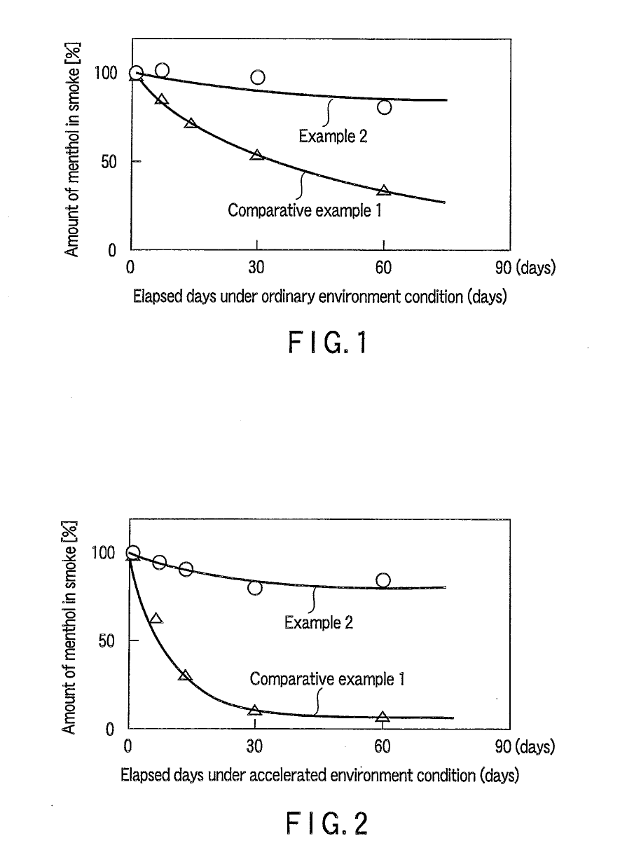

Also, cigarettes of Example 2 fitted with a charcoal filter were produced. Specifically, the cigarettes of Example 2 were fitted with a charcoal filter (a charcoal amount of 40 mg/filter), and the cigarettes were evaluated for the flavor-retaining property when the cigarettes were stored under ordinary environment conditions (22° C., and a humidity of 60%) and under accelerated environment conditions (as described above). FIG. 1 shows the results under the ordinary environment conditions, FIG. 2 shows the results under the accelerated environment conditions. The horizontal axis in FIG. 1 shows the elapsed days under the ordinary environment conditions, and that in FIG. 2 shows the elapsed days under the accelerated environment conditions. In each of FIGS. 1 and 2, the vertical axis shows the amount of menthol in smoke. In each of FIGS. 1 and 2, circular marks show the results for the cigarettes of Example 2, and triangular marks show those for the cigarettes of Comparative Example 1 described below.

### Comparative Example 1

Cigarettes equivalent to the current menthol products were produced. The menthol was added to cut tobacco by use of a solvent. In the same manner as in Example 2, the cigarettes were continued to be stored under ordinary environment conditions (22° C., and a humidity of 60%) and accelerated environment conditions (the above-mentioned environment imitating inside of a stock space of an automatic vending machine in summer), and then the flavor-retaining property was evaluated. The results are also shown in FIGS. 1 and 2.

From the measured results of the flavor-retaining property during a period of time in storage, it was clearly found the followings. The cigarettes of Example 2 had smaller reduction in the menthol amount in the smoke even when the elapsed days in storage increased, compared with the cigarettes of Comparative Example 1, to which menthol was added by use of the solvent in accordance with the production of the current products. This situation appeared as a remarkable difference, in particular, when the cigarettes were stored under the accelerated environment conditions imitating an automatic vending machine in summer shown in FIG. 2. Specifically, the cigarettes of Comparative Example 1, to which menthol was added by use of the solvent in accordance with the production of the current products, provided a menthol delivery of 0.571 mg per cigarette (with a ratio of menthol to tar of 0.062) before the storage. The cigarette samples stored in the form of a 20-cigarette package for three months under the ordinary environment conditions (temperature: 22° C., and humidity: 60%) provided a menthol delivery of 0.162 mg per cigarette (with a ratio of menthol to tar of 0.018), which was reduced to about ⅓ of that before the storage. By contrast, the cigarettes of Example 2 provided a menthol delivery of 0.803 mg per cigarette (with a ratio of menthol to tar of 0.084) before the storage. The cigarette samples stored in the form of a 20-cigarette package same as above for three months under the ordinary environment conditions provided a sufficient menthol delivery of 0.676 mg per cigarette (with a ratio of menthol to tar of 0.070). Thus, it was found that about 84% of the initial value before the storage was retained.

The cigarettes of Comparative Example 1 stored in the form of a 20-cigarette package for three months under the accelerated environment conditions, imitating an automatic vending machine in summer, provided a menthol delivery of 0.043 mg per cigarette (with a ratio of menthol to tar of 0.005), which was reduced to about 1/10 of that before the storage. By contrast, the cigarettes of Example 2 after the same elapsed period of storage provided a sufficient menthol delivery of 0.626 mg per cigarette (with a ratio of menthol to tar of 0.065). Thus, about 78% of the initial value before the storage could be retained.

From these results, it is confirmed that, when the flavor-containing material according to the invention is used to add a flavor component such as menthol to cigarettes, there are provided cigarettes which can exhibit a sufficient flavor amount (i.e., a sufficient flavor delivery) and a sufficient flavor-retaining property during storage.

### Example 4

A composition system of κ-carrageenan and locust bean gum (Bistop D-2050, San-Ei Gen F.F.I., Inc.), which is a galactomannan extracted from tree seeds, mixed at a weight ratio of 8:2 was selected as a polysaccharide, and l-menthol was selected as a flavor. A flavor-containing material for cigarette was prepared by the following procedures.

To 4 g of κ-carrageenan and 1 g of locust bean gum added was 100 mL of water, which was heated in a thermostat bath of 80° C. to dissolve the polysaccharides sufficiently in water. Added thereto were 25 g of 1-menthol and 2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 76 wt % of menthol. Thus, a satisfactory amount of menthol could be added.

The flavor-containing material for cigarette of Example 4 was blended in 5% by weight ratio to cut tobacco, and a cigarette with a tar value designed to about 10 mg was produced. At this time, the flavor-containing material for cigarette of Example 4 could be added without causing the problem of a stain on the wrapper. Further, the cigarette was fitted with a plain filter. The cigarette provided a menthol delivery of 1.82 mg per cigarette (with a ratio of menthol to tar of 0.170). This was a sufficient delivery for a menthol cigarette.

### Example 5

A composition system of κ-carrageenan and guar gum (Bistop D-2029, San-Ei Gen F.F.I., Inc.), which is a galactomannan extracted from tree seeds, mixed at a weight ratio of 8:2 was selected as a polysaccharide material, and l-menthol was selected as a flavor. A flavor-containing material for cigarette was prepared by the following procedures.

To 4 g of κ-carrageenan and 1 g of guar gum added was 100 mL of water, which was heated in a thermostat bath of 80° C. to dissolve the polysaccharides sufficiently in water. Added thereto were 25 g of 1-menthol and 2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 84 wt % of menthol. Thus, a satisfactory amount of menthol could be added.

The flavor-containing material for cigarette of Example 5 was blended in 5% by weight ratio to cut tobacco, and a cigarette with a tar value designed to about 10 mg was produced. At this time, the flavor-containing material for cigarette of Example 5 could be added without causing the problem of a stain on the wrapper. Further, the cigarette was fitted with a plain filter. The cigarette provided a menthol delivery of 1.80 mg per cigarette (with a ratio of menthol to tar of 0.173). This was a sufficient delivery for a menthol cigarette.

### Example 6

Agar (special grade, Wako Pure Chemical Industries, Ltd.), which is extracted from red algae seaweed, was selected as a single polysaccharide and 1-menthol was selected as a flavor. A flavor-containing material for cigarette was prepared by the following procedures.

To 5 g of powdery agar added was 100 mL of water, which was heated in a thermostat bath of 80° C. to dissolve agar sufficiently in water. Added thereto were 25 g of l-menthol and 2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 90 wt % of menthol. Thus, a satisfactory amount of menthol could be added.

The flavor-containing material for cigarette of Example 6 was blended in 5% by weight ratio to cut tobacco, and a cigarette with a tar value designed to about 10 mg was produced. At this time, the flavor-containing material for cigarette of Example 6 could be added without causing the problem of a stain on the wrapper. Further, the cigarette was fitted with a plain filter. The cigarette provided a menthol delivery of 2.15 mg per cigarette (with a ratio of menthol to tar of 0.201). This was a sufficient delivery for a menthol cigarette.

### Example 7

A composition system of gellan gum (Kelco gel, America CP Kelco), which is a polysaccharide produced by the metabolism of microorganisms, and tamarind gum (Bistop D-2032, San-Ei Gen F.F.I., Inc.), which is extracted from tree seeds and has a xyloglucan structure, mixed at a weight ratio of 1:1 was selected as a polysaccharide, and l-menthol was selected as a flavor. A flavor-containing material for cigarette was prepared by the following procedures.

To 1.0 g of gellan gum and 1.0 g of tamarind gum added was 100 mL of water, which was heated in a thermostat bath of 80° C. to dissolve the polysaccharides sufficiently in water. Added thereto were 10 g of 1-menthol and 1.6 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 85 wt % of menthol. Thus, a satisfactory amount of menthol could be added.

The flavor-containing material for cigarette of Example 7 was blended in 5% by weight ratio to cut tobacco, and a cigarette with a tar value designed to about 10 mg was produced. At this time, the flavor-containing material for cigarette of Example 7 could be added without causing the problem of a stain on the wrapper. Further, the cigarette was fitted with a plain filter. The cigarette provided a menthol delivery of 2.40 mg per cigarette (with a ratio of menthol to tar of 0.209). This was a sufficient delivery for a menthol cigarette.

### Example 8

A composition system of xanthan gum (SAN ACE NXG-S, San-Ei Gen F.F.I., Inc.), which is a polysaccharide produced by the metabolism of microorganisms, and locust bean gum mixed at a weight ratio of 1:1 was selected as a polysaccharide, and 1-menthol was selected as a flavor. A flavor-containing material for cigarette was prepared by the following procedures.

To 1.5 g of xanthan gum and 1.5 g of locust bean gum added was 100 mL of water, which was heated in a thermostat bath of 80° C. to dissolve the polysaccharides sufficiently in water. Added thereto were 15 g of 1-menthol and 1.2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 65 wt % of menthol. Thus, a satisfactory amount of menthol could be added.

The flavor-containing material for cigarette of Example 8 was blended in 5% by weight ratio to cut tobacco, and a cigarette with a tar value designed to about 10 mg was produced. At this time, the flavor-containing material for cigarette of Example 8 could be added without causing the problem of a stain on the wrapper. Further, the cigarette was fitted with a plain filter. The cigarette provided a menthol delivery of 2.25 mg per cigarette (with a ratio of menthol to tar of 0.184). This was a sufficient delivery for a menthol cigarette.

### Example 9

A composition system of xanthan gum and tara gum (Bistop D-2101, San-Ei Gen F.F.I., Inc.), which is a galactomannan extracted from tree seeds, mixed at a weight ratio of 1:1 was selected as a polysaccharide, and l-menthol was selected as a flavor. A flavor-containing material for cigarette was prepared by the following procedures.

To 1.5 g of xanthan gum and 1.5 g of tara gum added was 100 mL of water, which was heated in a thermostat bath of 80° C. to dissolve the polysaccharides sufficiently in water. Added thereto were 15 g of 1-menthol and 1.2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 77 wt % of menthol. Thus, a satisfactory amount of menthol could be added.

The flavor-containing material for cigarette of Example 9 was blended in 5% by weight ratio to cut tobacco, and a cigarette with a tar value designed to about 10 mg was produced. At this time, the flavor-containing material for cigarette of Example 9 could be added without causing the problem of a stain on the wrapper. Further, the cigarette was fitted with a plain filter. The cigarette provided a menthol delivery of 2.09 mg per cigarette (with a ratio of menthol to tar of 0.191). This was a sufficient delivery for a menthol cigarette.

### Example 10

A composition system of xanthan gum and konjak glucomannan (fine konjak powder, Konjak Material Commerce and Industry Co-Operative Association of Gunma Prefecture in Japan), which is extracted from tuberous roots of konjak, mixed at a weight ratio of 1:1 was selected as a polysaccharide, and l-menthol was selected as a flavor. A flavor-containing material for cigarette was prepared by the following procedures.

To 1.5 g of xanthan gum and 1.5 g of konjak glucomannan added was 100 mL of water, which was heated in a thermostat bath of 80° C. to dissolve the polysaccharides sufficiently in water. Added thereto were 15 g of l-menthol and 1.2 mL of a 5% aqueous solution of lecithin as an emulsifier, which was sufficiently emulsified by stirring with hand. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 76 wt % of menthol. Thus, a satisfactory amount of menthol could be added.

The flavor-containing material for cigarette of Example 10 was blended in 5% by weight ratio to cut tobacco, and a cigarette with a tar value designed to about 10 mg was produced. At this time, the flavor-containing material for cigarette of Example 10 could be added without causing the problem of a stain on the wrapper. Further, the cigarette was fitted with a plain filter. The cigarette provided a menthol delivery of 2.10 mg per cigarette (with a ratio of menthol to tar of 0.184). This was a sufficient delivery for a menthol cigarette.

### Example 11

A composition system of xanthan gum and tamarind gum mixed at a weight ratio of 1:1 was selected as a polysaccharide, and l-menthol was selected as a flavor. A flavor-containing material for cigarette was prepared by the following procedures.

To 1.5 g of xanthan gum and 1.5 g of tamarind gum added was 100 mL of water, which was heated in a thermostat bath of 80° C. to dissolve the polysaccharides sufficiently in water. Added thereto were 15 g of 1-menthol and 1.2 mL of a 5% aqueous solution of lecithin as an emulsifier, which was sufficiently emulsified by stirring with hand. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 67 wt % of menthol. Thus, a satisfactory amount of menthol could be added.

The flavor-containing material for cigarette of Example 11 was blended in 5% by weight ratio to cut tobacco, and a cigarette with a tar value designed to about 10 mg was produced. At this time, the flavor-containing material for cigarette of Example 11 could be added without causing the problem of a stain on the wrapper. Further, the cigarette was fitted with a plain filter. The cigarette provided a menthol delivery of 1.23 mg per cigarette (with a ratio of menthol to tar of 0.140). This was a sufficient delivery for a menthol cigarette.

### Example 12

A composition system of xanthan gum and starch (reagent originating from corn, Wako Pure Chemical Industries, Ltd.) mixed at a weight ratio of 1:1 was selected as a polysaccharide, and l-menthol was selected as a flavor. A flavor-containing material for cigarette was prepared by the following procedures.

To 2.0 g of xanthan gum and 2.0 g of starch added was 100 mL of water, which was heated in a thermostat bath of 80° C. to dissolve the polysaccharides sufficiently in water. Added thereto were 20 g of 1-menthol and 1.6 mL of a 5% aqueous solution of lecithin as an emulsifier, which was sufficiently emulsified by stirring with hand. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 50 wt % of menthol. Thus, a satisfactory amount of menthol could be added.

The flavor-containing material for cigarette of Example 12 was blended in 10% by weight ratio to cut tobacco, and a cigarette with a tar value designed to about 10 mg was produced. At this time, the flavor-containing material for cigarette of Example 12 could be added without causing the problem of a stain on the wrapper. Further, the cigarette was fitted with a plain filter. The cigarette provided a menthol delivery of 1.93 mg per cigarette (with a ratio of menthol to tar of 0.183). This was a sufficient delivery for a menthol cigarette.

### Example 13

A composition system of locust bean gum and a starch (reagent originating from corn, Wako Pure Chemical Industries, Ltd.) mixed at a weight ratio of 1:1; and a composition system of locust bean gum and a starch (soluble reagent, Wako Pure Chemical Industries, Ltd.) mixed at a weight ratio of 1:1 were selected as polysaccharides, and l-menthol was selected as a flavor. A flavor-containing material for cigarette was prepared by the following procedures.

To 2.5 g of locust bean gum and 2.5 g of each of the starches added was 100 mL of water, which was heated in a thermostat bath of 80° C. to dissolve the polysaccharides sufficiently in water. Added thereto were 25 g of l-menthol and 2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 65 wt % of menthol in the case of using the starch originating from corn, and was measured to contain about 25 wt % of menthol in the case of using the soluble starch. Thus, a satisfactory amount of menthol could be added.

Each of the flavor-containing materials for cigarette of Example 13 was blended in about 10% by weight ratio to cut tobacco in the case of using the starch originating from corn and in about 20% by weight ratio to cut tobacco in the case of using the soluble starch, and cigarettes with a tar value designed to about 10 mg were produced. At this time, each of the flavor-containing materials for cigarette of Example 13 could be added without causing the problem of a stain on the wrapper. Further, each of the cigarettes was fitted with a plain filter.

The cigarette using the starch originating from corn provided a menthol delivery of 2.59 mg per cigarette (with a ratio of menthol to tar of 0.209). The cigarette using the soluble starch provided a menthol delivery of 2.30 mg per cigarette (with a ratio of menthol to tar of 0.216). These were sufficient deliveries for menthol cigarettes.

### Example 14

Konjak glucomannan was selected as a single polysaccharide and l-menthol was selected as a flavor. A flavor-containing material for cigarette was prepared by the following procedures.

To 100 mL of water, while heated in a thermostat bath of 80° C., added were 25 g of l-menthol and 2 mL of a 5% aqueous solution of lecithin as an emulsifier for sufficient dissolving, which was sufficiently emulsified by means of a homogenizer. Added thereto was 5 g of konjak glucomannan while dissolving, which was further kneaded and emulsified. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 20 wt % of menthol. Thus, a satisfactory amount of menthol could be added.

The flavor-containing material for cigarette of Example 14 was blended in 20% by weight ratio to cut tobacco, and a cigarette with a tar value designed to about 10 mg was produced. At this time, the flavor-containing material for cigarette of Example 14 could be added without causing the problem of a stain on the wrapper. Further, the cigarette was fitted with a plain filter. The cigarette provided a menthol delivery of 2.05 mg per cigarette (with a ratio of menthol to tar of 0.203). This was a sufficient delivery for a menthol cigarette.

### Example 15

Tamarind gum was selected as a single polysaccharide and l-menthol was selected as a flavor. A flavor-containing material for cigarette was prepared by the following procedures.

To 3 g of tamarind gum added was 100 mL of water, which was heated in a thermostat bath of 80° C. to dissolve tamarind gum sufficiently in water. Added thereto were 15 g of l-menthol and 1.2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 18 wt % of menthol. Thus, a satisfactory amount of menthol could be added.

The flavor-containing material for cigarette of Example 15 was blended in 20% by weight ratio to cut tobacco, and a cigarette with a tar value designed to about 10 mg was produced. At this time, the flavor-containing material for cigarette of Example 15 could be added without causing the problem of a stain on the wrapper. Further, the cigarette was fitted with a plain filter. The cigarette provided a menthol delivery of 0.71 mg per cigarette (with a ratio of menthol to tar of 0.064). This was a sufficient delivery for a menthol cigarette.

### Example 16

Tamarind gum was selected as a single polysaccharide and l-menthol was selected as a flavor. A flavor-containing material for cigarette was prepared by the following procedures.

To 2 g of tamarind gum added was 100 mL of water, which was heated in a thermostat bath of 80° C. to dissolve tamarind gum sufficiently in water. Added thereto were 20 g of l-menthol and 1.2 mL of a 5% aqueous solution of lecithin as an emulsifier, which was sufficiently emulsified by means of a homogenizer. Added thereto was 40 mL of ethyl alcohol (special grade, Wako Pure Chemical Industries, Ltd.), which was emulsified further sufficiently by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 71 wt % of menthol. Thus, a satisfactory amount of menthol could be added.

The flavor-containing material for cigarette of Example 16 was blended in 5% by weight ratio to cut tobacco, and a cigarette with a tar value designed to about 10 mg was produced. At this time, the flavor-containing material for cigarette of Example 16 could be added without causing the problem of a stain on the wrapper. Further, the cigarette was fitted with a plain filter. The cigarette provided a menthol delivery of 2.20 mg per cigarette (with a ratio of menthol to tar of 0.187). This was a sufficient delivery for a menthol cigarette.

### Example 17

Gellan gum was selected as a single polysaccharide and l-menthol was selected as a flavor. A flavor-containing material for cigarette was prepared by the following procedures.

To 2 g of gellan gum added was 100 mL of water, which was heated in a thermostat bath of 80° C. to dissolve gellan gum sufficiently in water. Added thereto were 10 g of l-menthol and 1.6 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 80 wt % of menthol. Thus, a satisfactory amount of menthol could be added.

The flavor-containing material for cigarette of Example 17 was blended in 5% by weight ratio to cut tobacco, and a cigarette with a tar value designed to about 10 mg was produced. At this time, the flavor-containing material for cigarette of Example 17 could be added without causing the problem of a stain on the wrapper. Further, the cigarette was fitted with a plain filter. The cigarette provided a menthol delivery of 2.27 mg per cigarette (with a ratio of menthol to tar of 0.180). This was a sufficient delivery for a menthol cigarette.

### Example 18

A composition system of cassia gum (RheoRanger SR, Noveon, Inc. in USA), which is a galactomannan extracted from tree seeds, and K-carrageenan mixed at a weight ratio of 1:1 was selected as a polysaccharide, and l-menthol was selected as a flavor. A flavor-containing material for cigarette was prepared by the following procedures.

To 1.5 g of cassia gum and 1.5 g of K-carrageenan added was 100 mL of water, which was heated in a thermostat bath of 80° C. to dissolve the polysaccharides sufficiently in water. Added thereto were 15 g of 1-menthol and 1.2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 77 wt % of menthol. Thus, a satisfactory amount of menthol could be added.

The flavor-containing material for cigarette of Example 18 was blended in 5% by weight ratio to cut tobacco, and a cigarette with a tar value designed to about 10 mg was produced. At this time, the flavor-containing material for cigarette of Example 18 could be added without causing the problem of a stain on the wrapper. Further, the cigarette was fitted with a plain filter. The cigarette provided a menthol delivery of 0.94 mg per cigarette (with a ratio of menthol to tar of 0.094). This was a sufficient delivery for a menthol cigarette.

### Example 19

A composition system of cassia gum and xanthan gum mixed at a weight ratio of 7:3 was selected as a polysaccharide, and l-menthol was selected as a flavor. A flavor-containing material for cigarette was prepared by the following procedures.

To 2.1 g of cassia gum and 0.9 g of xanthan gum added was 100 mL of water, which was heated in a thermostat bath of 80° C. to dissolve the polysaccharides sufficiently in water. Added thereto were 15 g of 1-menthol and 1.2 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 77 wt % of menthol. Thus, a satisfactory amount of menthol could be added.

The flavor-containing material for cigarette of Example 19 was blended in 5% by weight ratio to cut tobacco, and a cigarette with a tar value designed to about 10 mg was produced. At this time, the flavor-containing material for cigarette of Example 19 could be added without causing the problem of a stain on the wrapper. Further, the cigarette was fitted with a plain filter. The cigarette provided a menthol delivery of 0.49 mg per cigarette (with a ratio of menthol to tar of 0.051). This was a sufficient delivery for a menthol cigarette.

### Example 20

Psyllium seed gum (PG 200, MRC Polysaccharide Co., Ltd.), which is extracted from tree seeds and is an acidic polysaccharide having a structure with a main chain of xylan and side chains of arabinose was selected as a single polysaccharide and l-menthol was selected as a flavor. A flavor-containing material for cigarette was prepared by the following procedures.

To 4 g of psyllium seed gum added was 100 mL of water, which was heated in a thermostat bath of 80° C. to dissolve the polysaccharide sufficiently in water. Added thereto were 20 g of l-menthol and 1.6 mL of a 5% aqueous solution of lecithin as an emulsifier, which was sufficiently emulsified by means of a homogenizer. This emulsified slurry was cast on a substrate into a sheet form, which was dried in a forced air circulation dryer of 40° C. for one week. At this time, the emulsified state of the mixture was kept until the flavor-containing material was dried.

The prepared sheet-form flavor-containing material for cigarette was measured to contain about 73 wt % of menthol. Thus, a satisfactory amount of menthol could be added.

The flavor-containing material for cigarette of Example 20 was blended in 5% by weight ratio to cut tobacco, and a cigarette with a tar value designed to about 10 mg was produced. At this time, the flavor-containing material for cigarette of Example 20 could be added without causing the problem of a stain on the wrapper. Further, the cigarette was fitted with a plain filter. The cigarette provided a menthol delivery of 0.66 mg per cigarette (with a ratio of menthol to tar of 0.066). This was a sufficient delivery for a menthol cigarette.

What is claimed is:

1. A flavor-containing material for cigarette, wherein a flavor is coated with a gel of a polysaccharide containing no gelling agent,
the material being provided by:
(i) mixing the polysaccharide with water and heating the mixture to prepare an aqueous solution of the polysaccharide, thereby imparting to the polysaccharide a property capable of gelling in standing to cool; and
(ii) adding a flavor and an emulsifier to the aqueous solution, and kneading and emulsifying it.

2. The flavor-containing material for cigarette according to claim 1, wherein the polysaccharide is a single component system of carrageenan, agar, gellan gum, tamarind gum, psyllium seed gum or konjak glucomannan, or a composition system of combined two or more components selected from the group consisting of carrageenan, locust bean gum, guar gum, agar, xanthan gum, gellan gum, tamarind gum, tara gum, konjak glucomannan, starch, cassia gum and psyllium seed gum.

3. The flavor-containing material for cigarette according to claim 1, wherein the flavor is contained in 18 wt % or more.

4. The flavor-containing material for cigarette according to claim 1, wherein the flavor is contained in 45 wt % or more.

5. The flavor-containing material for cigarette according to claim 1, wherein the flavor is in a solid or a liquid.

6. The flavor-containing material for cigarette according to claim 1, wherein it is shaped into a sheet form.

7. A process for producing a flavor-containing material for cigarette, comprising:
(i) mixing the polysaccharide with water and heating the mixture to prepare an aqueous solution of the polysaccharide, thereby imparting to the polysaccharide a property capable of gelling in standing to cool; and
(ii) adding a flavor and an emulsifier to the aqueous solution of the polysaccharide, and kneading and emulsifying it.

8. A cigarette, comprising a tobacco rod comprising cut tobacco and a cigarette wrapper wrapping the cut tobacco, wherein the flavor-containing material for cigarette according to claim 1 is added to the cut tobacco.

9. The cigarette according to claim 8, wherein the sheet-form flavor-containing material for cigarette according to claim 6 is shredded and added to the cut tobacco.

10. The cigarette according to claim 8, wherein the flavor-containing material for cigarette is added to the cut tobacco in a state of slurry.
